(19) United States
(12) Patent Application Publication
(10) Pub. No.: US 2024/0376338 A1
(43) Pub. Date: Nov. 14, 2024

(54) BIOBASED LATEX HAVING INCREASED C14 CONTENT, METHODS OF MAKING AND METHODS OF USING

(71) Applicant: SWIMC LLC, CLEVELAND, OH (US)

(72) Inventors: Barbara REZENDE LARA, Lyon (FR); Sebastien GIBANEL, Givry (FR); Philippe DELIGNY, Saint nom la breteche (FR)

(21) Appl. No.: 18/657,865

(22) Filed: May 8, 2024

Related U.S. Application Data
(60) Provisional application No. 63/465,567, filed on May 11, 2023.
(60) Provisional application No. 63/608,352, filed on Dec. 11, 2023.

(51) Int. Cl. C09D 133/08; C08F 220/18

(52) U.S. Cl. CPC C09D 133/08; C08F 220/1802

(57) ABSTRACT

A waterborne biobased acrylic (co)polymer is provided having structural units obtained from monomers including a biobased ethyl acrylate; at least one other (meth)acrylate; and, optionally, at least one styrene; wherein the waterborne acrylic (co)polymer contains at least 5% by weight of 14° C., as determined in accordance with ASTM D6866-22, coatings formed using the waterborne biobased acrylic (co)polymer and methods for producing the waterborne biobased acrylic (co)polymer.

### CROSS REFERENCE TO RELATED APPLICATIONS

The present application is related to, and claims priority to, U.S. Provisional Application No. 63/608,352, filed Dec. 11, 2023, the contents of which are herein incorporated by reference in their entirety. The present application is also related to, and claims priority to, U.S. Provisional Application No. 63/465,567, filed May 11, 2023, the contents of which are herein incorporated by reference in their entirety.

### TECHNICAL FIELD

In general, the present invention relates to a waterborne acrylic (co)polymer having a high content of biobased ethyl acrylate, such that the (co)polymer contains at least 5% by weight of ¹⁴C, coatings formed thereby, and methods of making the (co)polymer.

### BACKGROUND OF THE INVENTION

The US paint and coatings industry includes more than 1,000 companies with combined annual sales in excess of $20 billion and continues to grow. Polymer latexes are one of the most advanced polymeric materials produced for applications in coatings and paints. A unique process for producing polymer latexes with various properties is emulsion polymerization (free radical polymerization), which involves emulsification of monomers (or monomer mixtures) and their further polymerization resulting in the formation of latex particles from high molecular-weight polymers stabilized by surfactants in aqueous medium. This process is waterborne and does not involve any toxic or flammable solvents. Latex paints are considered much more environmentally friendly than conventional solvent borne systems (also called petrol-based systems).

Such waterborne polymer latexes represent a significant portion of the paints and coatings market. For example, about 70% of architectural paints sold in the United States are classified as waterborne paints. The second largest market for waterborne latexes is coatings that are applied on cars.

Advantages of using waterborne systems for such applications include low cost, ease of application and cleanup, reduced drying times, and low or no odor or emissions of volatile organic compounds (VOC). Currently, most acrylic dispersions are produced using monomers derived from oil based sources, i.e., fossil fuels. However, the movement toward environmental sustainability has provided an impetus for the development of copolymers utilizing as much raw material fitting within a sustainable framework as possible. For example, the LEED Green Building Rating System® requires that materials incorporate 5% of rapidly renewable materials, typically determined as % by weight of ¹⁴C present in the copolymer, as measured in accordance with ASTM D6866-22. Providing binders or coatings that can be utilized in building materials to help meet the requirements of the LEED Green Building Rating System® would be beneficial to the environment. However, it is also important that the binders or coatings maintain or even improve the properties that make them beneficial for their particular use.

Accordingly, there is a need for the development of waterborne acrylic (co)polymers having increased levels of ¹⁴C (thus increased amounts of biobased monomers such as ethyl acrylate) from the use of biobased monomer materials, while retaining or improving the properties of the produced (co)polymer.

### SUMMARY OF THE INVENTION

Accordingly, one object of the present invention is to provide a waterborne acrylic (co)polymer having a high content of biobased ethyl acrylate while maintaining coating performance and pricing compared to a petrol-based counterpart.

A further object of the present invention is to provide such a waterborne acrylic (co)polymer having increased ¹⁴C content, with improved water resistance and adhesion to substrates such as wood.

A further object of the present invention is to provide such a waterborne acrylic (co)polymer having a high content of biobased ethyl acrylate, while providing improved water resistance properties and faster water resistance recovery compared to petrol-based counterparts.

A further object of the present invention is to provide such a waterborne acrylic (co)polymer while achieving very low concentrations of residual ethyl acrylate.

Another object of the present invention is to provide a coating formed from the waterborne acrylic (co)polymer having a high content of biobased ethyl acrylate.

Still another object of the present invention is to provide a method for preparing the waterborne acrylic (co)polymer having a high content of biobased ethyl acrylate.

These and other objects of this invention, alone or in combinations, have been satisfied by the discovery of a waterborne acrylic (co)polymer having structural units obtained from monomers comprising a biobased ethyl acrylate; at least one other (meth)acrylate; and, optionally, at least one styrene; wherein the waterborne acrylic (co)polymer comprises at least 5% by weight of ¹⁴C,
a coating formed therefrom and methods for preparing the same.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIGS. 1A-1C are depictions of the water resistance and recovery properties of coatings formed from the waterborne acrylic (co)polymer of the present invention (LP2470+EA) compared to a comparable composition containing no biobased ethyl acrylate (containing only petrol-based ethyl acrylate) (LP2470 std) and compared to the petrol-based composition containing no butyl glycol (BG) (LP2470-BG), wherein FIG. 1A shows application of the compositions to PE (top) and mahogany (bottom) tables after 24 h exposure to water then removal of the water; FIG. 1B shows recovery of the same spots on the tables 20 minutes after removal of the water; and FIG. 1C shows recovery of the same spots on the tables 6 hours after removal of the water.

### DETAILED DESCRIPTION OF THE INVENTION

“Acrylic” as used herein includes (meth)acrylic acid, (meth)alkyl acrylate, (meth) acrylamide, (meth)acrylonitrile and their modified forms such as (meth)hydroxyalkyl acrylate. Throughout this document, the word fragment “(meth)acryl” refers to both “methacryl” and “acryl”. For example, (meth)acrylic acid refers to both methacrylic acid and acrylic acid, and methyl (meth)acrylate refers to both methyl methacrylate and methyl acrylate.

“Glass transition temperature” or “Tg” in the present invention can be measured by various conventional techniques including, for example, differential scanning calorimetry (“DSC”) or calculation by using a Fox equation. DSC data and methods described herein are in accordance with ASTM D6604-00.

“Aqueous” composition or dispersion herein means that particles are dispersed in an aqueous medium. An “aqueous medium” herein has a continuous phase of water that makes up at least 50 weight percent of the aqueous medium, wherein the remaining composition of the aqueous medium comprises particles and water-miscible compound(s) such as, for example, alcohols, glycols, glycol ethers, glycol esters, and the like.

As used herein, the term “(co)polymer” includes both homopolymers (polymers containing units from a single monomer) and copolymers (polymers containing units from two or more different monomers), unless otherwise specifically stated.

As used herein, the term “structural units”, also known as polymerized units, of the named monomer refers to the remnant of the monomer after polymerization, or the monomer in polymerized form.

The recitation of a numerical range using endpoints includes all numbers subsumed within that range (e.g., 1 to 5 includes 1, 1.5, 2, 2.75, 3, 3.80, 4, 5, etc.).

To the extent that the terms “including”, “includes”, “having”, “has”, “with”, or variants thereof are used in the present application, such terms are intended to be inclusive in a manner similar to the term “comprising.” The singular forms “a”, “an” and “the” include plural referents unless the context clearly dictates otherwise. Additionally, the terms “a,” “an,” “the,” “at least one,” and “one or more” are used interchangeably. Thus, for example, a coating composition that contains “an” additive means that the coating composition can include “one or more” additives. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

The present invention relates to a waterborne acrylic (co)polymer having structural units obtained from monomers comprising a biobased ethyl acrylate; at least one other (meth)acrylate monomer; and, optionally, at least one styrene monomer, such that the produced (co)polymer comprises at least 5% by weight of ¹⁴C, as measured in accordance with ASTM D6866-22. In preferred embodiments of the present invention, the produced (co)polymer comprises at least 10% by weight of ¹⁴C. In other preferred embodiments of the present invention, the produced (co)polymer comprises at least 15% by weight of ¹⁴C.

In terms of percentage of the (co)polymer formed from biobased ethyl acrylate, the biobased ethyl acrylate constitutes at least 30% by weight, preferably at least 40% by weight, more preferably at least 50% by weight, of the resulting waterborne acrylic (co)polymer.

In the present invention, the biobased ethyl acrylate can be derived from any plant based source, preferably from a source selected from corn, wheat, sugar beet, sugar cane, vegetable residues, vegetable oils, potatoes, or combinations thereof, more preferably from corn or wheat. The biobased ethyl acrylate is prepared from these plant based sources by conventional methods, such as those described and referenced in, for example, S. Briede, et al, “Acrylation of biomass: A review of synthesis process: Know-how and future application directions”, Current Opinion in Green and Sustainable Chemistry 2022, 35:100626, the entire contents of which are incorporated herein by reference.

Once polymerized, the (co)polymer of the present invention has a low level of residual biobased ethyl acrylate remaining in the formed (co)polymer, preferably less than 5% by weight based on total (co)polymer, more preferably less than 1% by weight, still more preferably less than 0.5% by weight, most preferably no detectable residual ethyl acrylate. Further, the resulting (co)polymer of the present invention has a low residual level of all monomers used, preferably less than 500 ppm, more preferably less than 300 ppm.

As the at least one additional (meth)acrylate monomer, any suitable (meth)acrylate monomer can be used. These additional (meth)acrylate monomers include, but are not limited to, (meth)acrylates, alkyl(meth)acrylates, (meth)acrylic acids, acrylamides, acrylonitriles, etc. and aromatic derivatives thereof. Exemplary (meth)acrylate monomers include methyl(meth)acrylate, ethyl(meth)acrylate, butyl(meth)acrylate, propyl(meth)acrylate, 2-ethyl hexyl(meth)acrylate, cyclohexyl(meth)acrylate, decyl(meth)acrylate, isobutyl(meth)acrylate, isodecyl(meth)acrylate, benzyl(meth)acrylate, isobornyl(meth)acrylate, neopentyl(meth)acrylate, 1-adamantyl methacrylate, acrylic acids such as (meth)acrylic acid, ethacrylic acid, alpha-chloroacrylic acid, alpha-cyanoacrylic acid, protonic acid, beta-acryloxy propionic acid, beta-styryl acrylic acid; etc. Mixtures of the foregoing can also be used.

In certain embodiments, the (co)polymer of the present invention includes a residue of any suitable aromatic monomer. Exemplary aromatic monomers include any one or more of styrene, chlorostyrene, alkyl styrenes, including, but not limited to, methyl styrene, propyl styrene, and t-butyl styrene, vinyl napthalene, vinyl toluene, divinyl benzene, etc. In preferred embodiments, the aromatic monomer is a styrene monomer, and the styrene monomer replaces at least a portion of the (meth)acrylate monomer of the composition. When present, the styrene units preferably constitute up to 35 wt % of the resulting (co)polymer, more preferably from 15 to 35 wt % of the resulting (co)polymer. The resulting (co)polymers containing structural units obtained from the styrene monomers have been found to have improved ethanol and ammonia resistance compared to formulations that do not contain the styrene based structural units.

The acrylic latex resin further can comprise any suitable phosphate-containing comonomer. Examples of phosphate-containing comonomers include bis (2-methacryloxyethyl) phosphate, monoacryloxyethyl phosphate, monolauryl(methacryloyloxy) phosphate, and so forth. Itaconate derivatives of these can also be used if desired.

Preferably the at least one additional (meth)acrylate monomer is a C1-C6 alkyl (meth)acrylate, more preferably a member selected from the group consisting of methyl methacrylate, methyl acrylate, ethyl methacrylate, isopropyl acrylate, isopropyl methacrylate, n-propyl acrylate, n-propyl methacrylate, n-butyl acrylate, n-butyl methacrylate, isobutyl acrylate, isobutyl methacrylate, t-butyl acrylate, t-butyl methacrylate, n-pentyl acrylate, n-pentyl methacrylate, isopentyl acrylate, isopentyl methacrylate, neopentyl acrylate, neopentyl methacrylate, n-hexyl acrylate, n-hexyl methacrylate, isohexyl acrylate, isohexyl methacrylate, neohexyl acrylate, neohexyl methacrylate, cyclobutyl acrylate, cyclobutyl methacrylate, cyclopentyl acrylate, cyclopentyl methacrylate, cyclohexyl acrylate, and cyclohexyl methacrylate.

The resulting waterborne acrylic (co)polymer can be uncrosslinked or crosslinked. The (co)polymer can be crosslinked by any suitable mechanism or chemical functionality. Exemplary (co)polymers can comprise a residue of a monomer including a moiety capable of reacting with a crosslinker provided in an aqueous phase of the waterborne (co)polymer of the invention. The crosslinking compound used in the present invention is preferably a difunctional crosslinking compound. One preferred embodiment of the present invention comprises polymers including a residue of diacetone acrylamide (DAAM) as the difunctional crosslinking compound, and an aqueous phase comprising adipic dihydrazide as a crosslinker. Without intending to be bound by any particular theory, it is thought that ketone groups of the residue of diacetone acrylamide react with the hydrazide groups on the adipic dihydrazide in the crosslinking reaction.

The waterborne acrylic (co)polymer can be a single-stage or multistage (co)polymer. Preferably the (co)polymer is a multistage (co)polymer, more preferably a two-phase (co)polymer having first and second phases of differing Tg's and/or differing weight average molecular weights. In one embodiment, the (co)polymer is a two-phase polymer comprising a first phase having a Tg of 50 to 150° C. and a second phase having a Tg of −50 to 40° C. In a further embodiment, the (co)polymer is a two-phase (co)polymer having a weight average molecular weight for a first phase (Mw1) of from 1000 to 150,000 g/mol, and a weight average molecular weight for a second phase (Mw2) of at least 80,000 g/mol.

Generally, a coating composition can be formulated using the waterborne biobased acrylic (co)polymer of the present invention. The coating composition also generally can comprise numerous other additives and components, as are conventional or as otherwise may be found suitable in a coating composition. Examples of suitable additives may include, but are not limited to, any one or more of neutralizing agents, antifoaming agents, fillers, dyes, dispersants, surfactants, extenders, adhesion promoters, wetting agents, rheology modifiers, leveling agents, deflocculants, anti-blocking agents, antimicrobials such as mildewcides, fungicides, algaecides, and bactericides, other preservatives, thickeners, thixotropic agents, drying agents, anti-settling agents, rust inhibitors, flattening agents, pigments, hardeners, and combinations thereof. When used, such additives may be present in any amounts suitable for their intended purposes. It is contemplated that some additives will play multiple roles in a coating com-position. Suitable examples of the various optional components are presented herein and also disclosed in U.S. Pat. No. 8,993,110, the relevant portions of which are incorporated by reference herein.

Any suitable rheology modifier may be incorporated into a coating composition. Examples of polyurethane rheology modifiers may include, but are not limited to, nonionic, solvent-free, hydrophobically modified ethylene oxide urethane (HEUR) rheology modifiers and nonionic urethane rheology modifiers.

The coating composition can include any suitable surfactant. In some embodiments, a phosphate surfactant can be included in a coating composition of the present invention. Examples of phosphate surfactants may include, but are not limited to, phosphate esters such as 2-ethylhexyl phosphate, decyl alcohol ethoxylated phosphate esters, lauryl alcohol ethoxylated phosphate esters, n-octyl phosphate, nonylphenol ethoxylated phosphate esters, octyl phenol ethoxylated phosphate esters, styrenated phenol ethoxylated phosphate esters, tridecyl alcohol ethoxylated phosphate esters, etc. In certain embodiments, the waterborne biobased acrylic (co)polymer of the present invention may comprise a phosphate-containing comonomer and may incorporate a phosphate surfactant. In some embodiments, the surfactant can be a reactive surfactant, including, but not limited to, reactive anionic surfactants and reactive nonionic surfactants.

Any suitable dispersant, such as any one or more of anionic dispersants, cationic dispersants, amphoteric dispersants, or nonionic dispersants may be used in the coating composition. Examples of suitable dispersants may include, but are not limited to, 2-amino-2-methyl-1-propanol (which can act as a dispersant and/or a neutralizing agent), pyrophosphates such as tetrapotassium pyrophosphate and tetrasodium pyrophosphate, tripolyphosphates such as potassium tripolyphosphate and sodium tripolyphosphate, etc. Any suitable wetting agents such as any one or more of anionic wetting agents, cationic wetting agents, amphoteric wetting agents, or nonionic wetting agents may be used. Any suitable deflocculant, such as sodium potassium tripolyphosphate, can be used.

The coating composition may include any suitable humectant or other component suitable to improve the open time of the composition. Exemplary open time extenders include glycols such as ethylene glycol and propylene glycol. When used, the open time extenders can be used in any suitable amounts. For example, ethylene and propylene glycol may be used in amounts of at least 5 g/L, and preferably are used in amounts ranging from 40 to less than 50 g/L. Generally, the glycols may be used in amounts sufficient to improve the open time of the composition but such that the composition has a volatile organic compounds (VOC) content of less than 50 g/L as determined by ASTM D6886-22. The ASTM test is believed to operate within a margin of error of about +6 g/L; in practice, a composition that yields a result of less than about 56 g/L under this test will be deemed to be a composition that has a VOC content of less than 50 g/L. In some embodiments, the coating composition is essentially free of VOCs except for the ethylene or propylene glycol or other open time extenders.

The coating composition may, if desired, include one or more fillers or extenders. Examples of fillers may include, but are not limited to, sodium-potassium alumina silicates, calcium carbonate, and the like. When used, such fillers may be employed in any desired amount.

Useful antimicrobial additives include phosphates, zeo-lites, hydroxyapatites, organic acids, phenols, alcohols, qua-ternary ammonium compounds, additives containing metal ions such as ions of silver, zinc, and copper, etc.

Any suitable drying agent may be included in a coating composition. Examples of suitable drying agents may include, but are not limited to, metal-based catalysts such as an iron-complex catalyst, a cobalt-free and metal-based catalyst, a zirconium-based catalyst, and the like. Preferably, suitable drying agents are free of VOCs.

One or more types of pigment may be included in a coating composition via any suitable technique, such as by adding raw pigment or a pigment vehicle during manufacture of the composition or by instilling a pigment at the point of sale. Examples of suitable pigments may include, but are not limited to, azo pigments, anazurite, aluminum silicate, aluminum potassium silicate, aluminum paste, anthraquinone pigments, antimony oxide, barium metaborate, barium sulfate, cadmium sulfide, cadmium selenide, calcium carbonate, calcium metaborate, calcium meta-silicate, carbon black, chromium oxides, clay, copper oxides, copper oxychloride, dioxazine pigments, feldspar, hansa yellows azo pigments (some of which are listed above), benzimidazolones, iron oxides such as yellow and red iron oxides, isoindoline pigments, kaolinite, lithopone, magnesium silicates, metallic flakes, mica, napthol pigments such as napthol reds, nitroso pigments, nepheline syenite, perinone pigments, perylene pigments, polycyclic pigments, pyrropyrrol pigments, pthalocyanines such as copper pthalocyanine blue and copper pthalocyanine green, quinacridones such as quinacridone violets, quinophthalone pigments, silicates, sulfides, talc, titanium dioxide, ultramarine, zinc chromate, zinc oxide, and zinc phosphate. In addition, pearlescents, optical brighteners, ultraviolet stabilizers, and the like may be added to a coating composition. Titanium dioxide is a preferred pigment/whitening agent.

Upon applying the coating composition to a substrate, the composition will cure to form a cured coating. In some embodiments, initial curing periods span a period of, for example, less than four weeks from the time of application of a coating composition. In some embodiments, initial curing periods range from, for example, eighteen hours to four weeks, one day to three weeks, three days to two weeks, and one week to two weeks.

Once prepared, the coating composition may be dispensed into any desired storage container, such as a paint can. The coating composition then may be transported and stored, such as in a warehouse or on a store shelf.

A method of applying a coating composition can comprise applying the coating composition to a substrate, and allowing the coating composition to cure. Once applied to the substrate, the coating composition will cure, typically as the composition crosslinks.

The coating composition may be employed for any suitable purpose. In some embodiments, the coating composition may be applied to interior or exterior architectural surfaces such as wood, metal, glass, plastic, paper, leather, fabric, ceramic, and combinations thereof, or over a primer coating. In preferred embodiments, the coating composition is applied to wood substrates, providing improved water resistance properties, and faster water resistance recovery, relative to petrol-based (non biobased) products having the same Tg. The coating composition may be applied with brush, roller, sponge, or spray gun, or other conventional painting tool. The cured coating may have any suitable thickness, such as a thickness ranging from 0.05-2 mm with preferred thickness around 0.1 mm.

The waterborne acrylic (co)polymer of the present invention can be prepared by any desired polymerization method, preferably by radical polymerization in an aqueous medium. The process for preparing the (co)polymer of the present invention preferably comprises providing a monomer mixture comprising a biobased ethyl acrylate; and at least one other (meth)acrylate; combining a first portion of the monomer mixture with a solvent comprising water in a heated reactor; adding at least one initiator composition to the first portion of the monomer mixture and solvent in the heated reactor to cause initiation of polymerization and an exotherm; and mixing the resulting mixture at a temperature of maximum exotherm. In certain embodiments, the first portion of monomer mixture and the at least one initiator composition comprises all of the monomer mixture and initiator to form the (co)polymer. In other embodiments, the monomers and initiator(s) can be added in multiple steps. Once all monomers and initiators are added, the resulting mixture is agitated until homogeneous, thus providing the waterborne acrylic (co)polymer.

In one embodiment of the process, the biobased ethyl acrylate and the at least one additional (meth)acrylate monomer are combined in a feed tank along with a crosslinker, such as diacetone acrylamide as noted above. These components are mixed in the feed tank until all are completely solubilized. The resulting mixture can be added to a reactor containing one or more initiators either in a single addition, or in a plurality of steps, depending on the desired (co)polymer, while also adding initiator(s) in a single step or a plurality of steps. Preferably, the reaction is exothermic, and the reacting mixture is mixed at maximum exotherm to complete the polymerization, preferably for 2 to 20 minutes, more preferably 3-10 minutes, most preferably 3-7 minutes. The process can be adapted to provide a single stage or multistage (co)polymer, depending on the desired end product.

In certain embodiments, the one or more initiators may be added in a plurality of additions at desired times during the reaction of the monomer mixture in order to control the heat generated by the exothermic polymerization reaction as desired. Following the exothermic reaction, the polymerization can be completed by addition of a further crosslinker agent, such as adipic dihydrazide, followed by mixing and cooling. An optional preservative can be added to the final (co)polymer mixture.

The mixing and reacting steps of the method can be done at any desired temperature from room temperature to less than 100° C., preferably from 25° C. to 75° C. Because of the exothermic nature of the polymerization, the mixing and reacting steps may or may not require external addition of heat, depending on where one is in the process.

All methods described herein can be performed in any suitable order unless otherwise indicated herein or otherwise clearly contradicted by context. The use of any examples, or language describing an example (e.g., “such as”) provided herein, is intended to illuminate the invention and does not pose a limitation on the scope of the invention. Any statement herein as to the nature or benefits of the invention or of the preferred embodiments is not intended to be limiting. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context. The description herein of any reference or patent, even if identified as “prior,” is not intended to constitute a concession that such reference or patent is available as prior art against the present invention. No unclaimed language should be deemed to limit the invention in scope. Any statements or suggestions herein that certain features constitute a component of the claimed invention are not intended to be limiting unless reflected in the appended claims. Neither the marking of the patent number on any product nor the identification of the patent number in connection with any service should be deemed a representation that all embodiments described herein are incorporated into such product or service.

While the embodiments discussed herein have been related to the (co)polymers, coatings and methods discussed above, these embodiments are intended to be examples only and are not intended to limit the applicability of these embodiments to only those discussions set forth herein.

The above description is merely illustrative of several possible embodiments of various aspects of the present invention, wherein equivalent alterations and/or modifications will occur to others skilled in the art upon reading and understanding this specification and the annexed drawings. In addition, although a particular feature of the invention may have been disclosed with respect to only one of several implementations, such feature may be combined with one or more other features of the other implementations as may be desired and advantageous for any given or particular application.

### Examples

The following examples are provided to illustrate the present invention and its advantages, but should not be construed as limiting a scope of the invention.

Three binder formulations were prepared: (1) Formulation “A”, a commercially available water based, pure acrylic copolymer emulsion; (2) Formulation “B”, equivalent to Formulation “A” but prepared without the presence of butyl glycol (BG); and (3) Formulation “C”, equivalent to Formulation “A” but prepared using 54% of biobased ethyl acrylate (instead of petrol-derived ethyl acrylate) and containing no BG, to arrive at a content of 15.41% of ¹⁴C. Each of these binders was then used to prepare a coating composition wherein, with the three formulations prepared using A, B, or C as the only binder, respectively, without matting agents. The resulting coating formulations are abbreviated below using the binder identifiers: A, B, or C.

Each coating formulation noted above (A; B; and C) was applied to a wood substrate of beech wood at a depth of 150μ and dried at 7° C. The results were as follows:

| | |
|---|---|
| A | No Film Forming |
| B | No Film Forming |
| C | At limit Film Forming |

Using the three coating compositions prepared above, a resistance to cold liquids test was run on the coatings system according to CEN/TS 16209 using both Level A and Level B conditions described in the test method. Testing under CEN/TS 16209 provides the following ratings scale: 5—no visible change; 4—slight change in gloss level or colour that can be identified under particular view conditions only; 3—moderate change in gloss level or colour and/or barely visible ring-shaped or circle mark; 2—marked sign with definite change in gloss level or colour and/or visible ring-shaped or circle mark; and 1—marked sign showing total or partial surface deterioration. Application times are listed in hours (h), minutes (m), and seconds(s).

Each coating formulation was then applied to beech wood at a depth of 2×150μ and dried at room temperature, and the resistance to cold liquids test (noted above), run using coffee, ethanol (48%) and ammonia (10%) for the time periods shown in the table below. The results were:

| | 1 h coffee | 1 h ethanol 48% | 1 h ammonia 10% |
|---|---|---|---|
| A | 5 | 4 | 2 |
| B | 5 | 4 | 2 |
| C | 5 | 4 | 2 |

Each coating formulation was then sprayed on PE (polyester) 1×120 g/m² and dried at room temperature. Resistance to cold liquids testing was performed using ethanol (48%), ammonia (10%), acetone, and water, for the time periods shown in the table below, with the following results:

| | 1 h ethanol 48% | 1 h ammonia 10% | 10 s acetone | 24 h water |
|---|---|---|---|---|
| A | 3 | 3 | 3 | White stain+ and blistering+ |
| B | 3 | 3 | 3 | White stain and blistering |
| C | 3 | 2 | 3 | White stain− |

Each coating formulation was then sprayed on mahogany 2×120 g/m² and dried at room temperature. Resistance to cold liquids testing was performed using ethanol (48%), ammonia (10%) and water, for the time periods shown in the table below, with the following results:

| | 1 h ethanol 48% | 1 h ammonia 10% | 24 h water |
|---|---|---|---|
| A | 3 | 2 | Slightly white stain |
| B | 3 | 2 | Very slightly white stain |
| C | 3 | 2 | Slightly white stain |

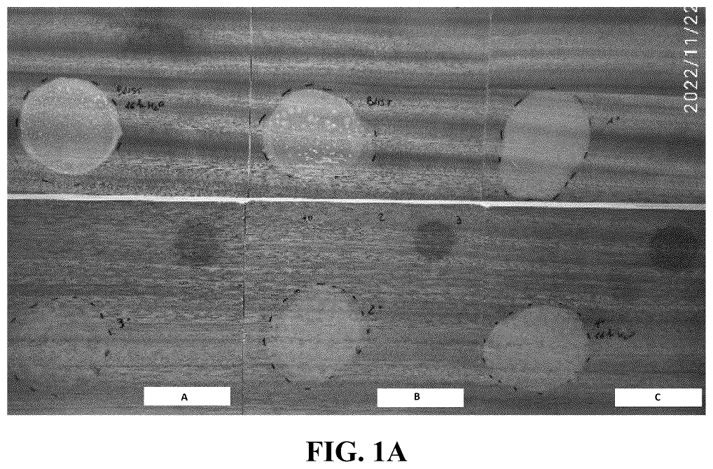

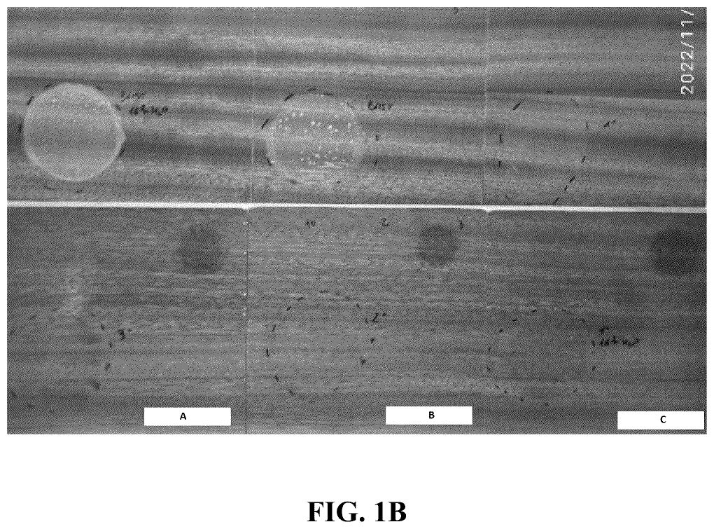

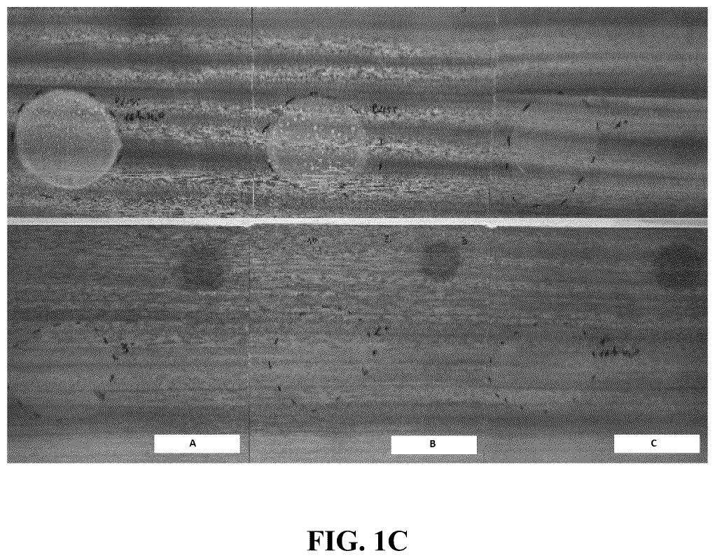

FIG. 1A shows the results for the resistance to cold liquids test for water for both the PE and mahogany tests after exposure to water for 24 hours, then removing the water. FIG. 1B shows the same test pieces after a 20 minute recovery time, and FIG. 1C shows the same test pieces after a 6 hour recovery time. As seen in these data and Figures, the coating composition containing the waterborne biobased acrylic (co)polymer of the present invention (C) exhibited comparable resistance to cold liquids to the standard (A) and the standard without BG (B), and significantly improved recovery in water resistance.

Each coating formulation was then applied to black Plexiglass at a thickness of 150μ and dried at room temperature and tested for staining upon exposure to water for 24 hours. The present invention coating composition containing the biobased ethyl acrylate showed slightly improved resistance to water staining compared to the other two coating formulations.

A paste was formed from each coating formulation containing 20% white pigment, and each paste formulation applied at 150μ thickness on melamine paper, followed by drying at room temperature. The following tests were performed, including resistance to cold liquids using coffee and ethanol (48%):

| | | 1 h | | | | |
|---|---|---|---|---|---|---|
| | 1 h | ethanol | Indentation | Depth | Hardness | Crosscut |
| | coffee | 48% | Buchholz (μ) | 8*((Indent/1000)*(Indent/1000)) | 100/(Indent/1000) | 2 mm |
| A | 1 | 3 | 1641 | 21.54 | 60.9 | 0 |
| B | 3 | 1 | 1658 | 21.99 | 60.3 | 0 |
| C | 2 | 3 | 1738 | 24.17 | 57.5 | 0 |

These data and Figures show that the present invention waterborne biobased acrylic (co)polymer provides easier film forming at low temperatures and better performance in water resistance on PE and black plexiglass, and similar or better performance in water resistance on mahogany compared to the standard formulation and the formulation without BG. In all cases the present invention composition was the first to become white upon water exposure, but had faster recovery than either of the comparison compositions. Additionally, the present invention composition requires less thickener (BG) to be present in the formulation, adding to its advantages compared to standard formulations.

In further tests, compositions of the present invention (co)polymer were prepared containing sufficient ¹⁴C ethyl acrylate to provide a ¹⁴C level of at least 15 wt %. Formulations D-F included (D) a composition of the present invention containing no styrene based units, (E) a composition of the present invention containing approximately equivalent amounts of methyl methacrylate units and styrene based units, and (F) a composition of the present invention wherein all of the methyl methacrylate units have been replaced by styrene units, with a small amount of butyl methacrylate units as the (meth)acrylate units. The compositions exhibited similar physicochemical properties to those tested above, with minimum film forming temperatures in the range from 25-29° C., and viscosities from 85 to 115 cp. These compositions of the present invention also exhibited two stage glass transition temperatures as described above, and provided low residual monomer levels of 300 ppm or less.

Each coating formulation was then applied to beech wood at a depth of 2×150μ and dried at room temperature, and the resistance to cold liquids test (noted above), run using coffee, ethanol (48%) and ammonia (10%) for the time periods shown in the table below. The results were:

| | 1 h coffee | 1 h ethanol 48% | 1 h ammonia 10% |
|---|---|---|---|
| D | 5 | 3 | 2 |
| E | 5 | 3 | 2 |
| F | 5 | 3.5 | 2 |

Each coating formulation was then sprayed on PE (polyester) 1×120 g/m² and dried at room temperature. Resistance to cold liquids testing was performed using ethanol (48%), ammonia (10%), and acetone, for the time periods shown in the table below, with the following results:

| | 1 h ethanol 48% | 1 h ammonia 10% | 10 s acetone |
|---|---|---|---|
| D | 3 | 2 | 3 |
| E | 3 | 2 | 3 |
| F | 3.5 | 2 | 3.5 |

Each coating formulation was then sprayed on mahogany 2×120 g/m² and dried at room temperature. Resistance to cold liquids testing was performed using ethanol (48%) and ammonia (10%), for the time periods shown in the table below, with the following results:

| | 1 h ethanol 48% | 1 h ammonia 10% |
|---|---|---|
| D | 3 | 2 |
| E | 3 | 2 |
| F | 3.5 | 2.5 |

The results using these (co)polymers D-F showed improved chemical resistance to ethanol and acetone for samples in which at least some of the (meth)acrylate monomers were replaced with styrene monomers. Further, the resulting polymers had significantly low free-monomer levels of 300 ppm or less, and Tg's that were comparable to standard formulations containing no ¹⁴C based ethyl acrylate.

The following are non-limiting examples of some embodiments of the present invention:
Embodiment 1. A waterborne acrylic (co)polymer having structural units obtained from monomers comprising:
   a biobased ethyl acrylate;
   at least one other (meth)acrylate; and
   optionally, at least one styrene;
wherein the waterborne acrylic (co)polymer comprises at least 5% by weight of ¹⁴C, as determined in accordance with ASTM D6866-22.
Embodiment 2. The waterborne acrylic (co)polymer of Embodiment 1, wherein a residual of the biobased ethyl acrylate after polymerization is less than 5% by weight based on total amount of waterborne acrylic (co)polymer.
Embodiment 3. The waterborne acrylic (co)polymer one of Embodiments 1 or 2, wherein the waterborne acrylic (co)polymer comprises at least 10% by weight of ¹⁴C.
Embodiment 4. The waterborne acrylic (co)polymer of any one of Embodiments 1-3, wherein the biobased ethyl acrylate is derived from corn, wheat, sugar beet, sugar cane, vegetable residues, potatoes, or combinations thereof.
Embodiment 5. The waterborne acrylic (co)polymer of Embodiment 1, wherein the waterborne acrylic (co)polymer comprises at least 30% by weight of the biobased ethyl acrylate.
Embodiment 6. The waterborne acrylic (co)polymer of any one of Embodiments 1-5, wherein the residual is less than 1% by weight.
Embodiment 7. The waterborne acrylic (co)polymer of Embodiment 6, wherein the residual is less than 0.5% by weight.
Embodiment 8. The waterborne acrylic (co)polymer of Embodiment 7, wherein the waterborne acrylic (co)polymer has no detectable residual of the biobased ethyl acrylate. Embodiment 9. The waterborne acrylic (co)polymer of any one of Embodiments 1-8, wherein the at least one other (meth)acrylate is a member selected from the group consisting of (meth)acrylates, alkyl(meth)acrylates, (meth)acrylic acids, acrylamides, acrylonitriles, and aromatic derivatives thereof.
Embodiment 10. The waterborne acrylic (co)polymer of any one of Embodiments 1-9, wherein the at least one other (meth)acrylate is at least one alkyl(meth)acrylate.
Embodiment 11. The waterborne acrylic (co)polymer of Embodiment 10, wherein the at least one alkyl(meth)acrylate is a C1-C6 alkyl(meth)acrylate.
Embodiment 12. The waterborne acrylic (co)polymer of any one of Embodiments 1-11, wherein the at least one other (meth)acrylate is at least one member selected from the group consisting of methyl methacrylate, methyl acrylate, ethyl methacrylate, isopropyl acrylate, isopropyl methacrylate, n-propyl acrylate, n-propyl methacrylate, n-butyl acrylate, n-butyl methacrylate, isobutyl acrylate, isobutyl methacrylate, t-butyl acrylate, t-butyl methacrylate, n-pentyl acrylate, n-pentyl methacrylate, isopentyl acrylate, isopentyl methacrylate, neopentyl acrylate, neopentyl methacrylate, n-hexyl acrylate, n-hexyl methacrylate, isohexyl acrylate, isohexyl methacrylate, neohexyl acrylate, neohexyl methacrylate, cyclobutyl acrylate, cyclobutyl methacrylate, cyclopentyl acrylate, cyclopentyl methacrylate, cyclohexyl acrylate, and cyclohexyl methacrylate.
Embodiment 13. The waterborne acrylic (co)polymer of any one of Embodiments 1-12, wherein the at least one styrene is present and is a member selected from the group consisting of styrene, alkyl styrenes, and chlorostyrene.
Embodiment 14. The waterborne acrylic (co)polymer of any one of Embodiments 1-13, wherein the waterborne acrylic (co)polymer is a two-phase polymer with a first phase having a Tg of 50 to 150° C. and a second phase having a Tg of −50 to 40° C.
Embodiment 15. The waterborne acrylic (co)polymer of any one of Embodiments 1-14, wherein the waterborne acrylic (co)polymer is a two-phase polymer having a weight average molecular weight for a first phase (Mw1) of from 1000 to 150,000 g/mol, and a weight average molecular weight for a second phase (Mw2) of at least 80,000 g/mol.
Embodiment 16. The waterborne acrylic (co)polymer of any one of Embodiments 1-15, wherein the waterborne acrylic (co)polymer has a residual free-monomer level of less than 500 ppm, based on total amount of waterborne acrylic (co)polymer
Embodiment 17. The waterborne acrylic (co)polymer of any one of Embodiments 1-16, further comprising units obtained from a difunctional crosslinking compound.
Embodiment 18. The waterborne acrylic (co)polymer of Embodiment 17, wherein the difunctional crosslinking compound is diacetone acrylamide.
Embodiment 19. A coating comprising the waterborne acrylic (co)polymer system of any of Embodiments 1-18.
Embodiment 20. The coating of Embodiment 19, wherein the coating is at least partially applied onto a substrate, wherein the substrate comprises a material selected from the group consisting of wood, metal, glass, plastic, paper, leather, fabric, ceramic, and combinations thereof.
Embodiment 21. The coating of one of Embodiments 19 or 20, further comprising:
   at least one component selected from the group consisting of thickeners, defoamers, surfactants, dispersants, matting agents, solvents, antimicrobial agents, pigments, hardeners, and combinations thereof.
Embodiment 22. A process for preparing the waterborne acrylic (co)polymer of any of Embodiments 1-18, comprising:
   providing a monomer mixture comprising a biobased ethyl acrylate; at least one other (meth)acrylate; and, optionally, at least one styrene;
   combining a first portion of the monomer mixture with a solvent comprising water in a heated reactor;
   adding at least one first initiator composition to the first portion of the monomer mixture and solvent in the heated reactor to cause initiation of polymerization and an exotherm;
   mixing the resulting mixture at a temperature of maximum exotherm;
   adding the remaining portion of the monomer mixture to the reactor; and
   adding further at least one second initiator composition and agitating the resulting mixture until homogeneous,
   thus providing the waterborne acrylic (co)polymer.
Embodiment 23. The process of Embodiment 22, wherein the at least one first initiator composition and the at least one second initiator composition comprise the same initiator.
Embodiment 24. The process of Embodiment 22, wherein at least one first initiator composition and the at least one second initiator composition comprise different initiators from one another.
Embodiment 25. The process of Embodiment 22, wherein the process uses three initiator compositions, each different from the other.
Embodiment 26. The process of any one of Embodiments 22-25, further comprising addition of at least one difunctional crosslinking compound.
Embodiment 27. The process of Embodiment 26, wherein the difunctional crosslinking compound is diacetone acrylamide.
Embodiment 28. The process of one of Embodiments 26 or 27, further comprising addition of a further crosslinking compound reactive with the difunctional crosslinking compound.
Embodiment 29. The process of any one of Embodiments 26-28, further comprising addition of adipic dihydrazide.

Additional modifications and variations of the present invention are possible in light of the above teachings. It is therefore to be understood that within the scope of the appended claims, the invention may be practiced otherwise than as specifically described herein.

What is claimed is:

1. A waterborne acrylic (co)polymer having structural units obtained from monomers comprising:
a biobased ethyl acrylate;
at least one other (meth)acrylate; and
optionally, at least one styrene;
wherein the waterborne acrylic (co)polymer comprises at least 5% by weight of ¹⁴C, as determined in accordance with ASTM D6866-22.

2. The waterborne acrylic (co)polymer of claim 1, wherein a residual of the biobased ethyl acrylate after polymerization is less than 5% by weight based on total amount of waterborne acrylic (co)polymer.

3. The waterborne acrylic (co)polymer claim 1, wherein the waterborne acrylic (co)polymer comprises at least 10% by weight of ¹⁴C.

4. The waterborne acrylic (co)polymer of claim 1, wherein the biobased ethyl acrylate is derived from corn, wheat, sugar beet, sugar cane, vegetable residues, potatoes, or combinations thereof.

5. The waterborne acrylic (co)polymer of claim 1, wherein the waterborne acrylic (co)polymer comprises at least 30% by weight of the biobased ethyl acrylate.

6. The waterborne acrylic (co)polymer of claim 2, wherein the residual is less than 1% by weight.

7. The waterborne acrylic (co)polymer of claim 6, wherein the residual is less than 0.5% by weight.

8. The waterborne acrylic (co)polymer of claim 7, wherein the waterborne acrylic (co)polymer has no detectable residual of the biobased ethyl acrylate.

9. The waterborne acrylic (co)polymer of claim 1, wherein the at least one other (meth)acrylate is a member selected from the group consisting of (meth)acrylates, alkyl(meth)acrylates, (meth)acrylic acids, acrylamides, acrylonitriles, and aromatic derivatives thereof.

10. The waterborne acrylic (co)polymer of claim 8, wherein the at least one other (meth)acrylate is at least one alkyl(meth)acrylate.

11. The waterborne acrylic (co)polymer of claim 10, wherein the at least one alkyl (meth)acrylate is a C1-C6 alkyl(meth)acrylate.

12. The waterborne acrylic (co)polymer of claim 1, wherein the at least one other (meth)acrylate is at least one member selected from the group consisting of methyl methacrylate, methyl acrylate, ethyl methacrylate, isopropyl acrylate, isopropyl methacrylate, n-propyl acrylate, n-propyl methacrylate, n-butyl acrylate, n-butyl methacrylate, isobutyl acrylate, isobutyl methacrylate, t-butyl acrylate, t-butyl methacrylate, n-pentyl acrylate, n-pentyl methacrylate, isopentyl acrylate, isopentyl methacrylate, neopentyl acrylate, neopentyl methacrylate, n-hexyl acrylate, n-hexyl methacrylate, isohexyl acrylate, isohexyl methacrylate, neohexyl acrylate, neohexyl methacrylate, cyclobutyl acrylate, cyclobutyl methacrylate, cyclopentyl acrylate, cyclopentyl methacrylate, cyclohexyl acrylate, and cyclohexyl methacrylate.

13. The waterborne acrylic (co)polymer of claim 1, wherein the at least one styrene is present and is a member selected from the group consisting of styrene, alkyl styrenes, and chlorostyrene.

14. The waterborne acrylic (co)polymer of claim 1, wherein the waterborne acrylic (co)polymer is a two-phase polymer with a first phase having a Tg of 50 to 150° C. and a second phase having a Tg of −50 to 40° C.

15. The waterborne acrylic (co)polymer of claim 1, wherein the waterborne acrylic (co)polymer is a two-phase polymer having a weight average molecular weight for a first phase (Mw1) of from 1000 to 150,000 g/mol, and a weight average molecular weight for a second phase (Mw2) of at least 80,000 g/mol.

16. The waterborne acrylic (co)polymer of claim 1, wherein the waterborne acrylic (co)polymer has a residual free-monomer level of less than 500 ppm, based on total amount of waterborne acrylic (co)polymer.

17. The waterborne acrylic (co)polymer of claim 1, further comprising units obtained from a difunctional crosslinking compound.

18. The waterborne acrylic (co)polymer of claim 17, wherein the difunctional crosslinking compound is diacetone acrylamide.

19. A coating comprising the waterborne acrylic (co)polymer system of claim 1.

20. The coating of claim 19, wherein the coating is at least partially applied onto a substrate, wherein the substrate comprises a material selected from the group consisting of wood, metal, glass, plastic, paper, leather, fabric, ceramic, and combinations thereof.

21. The coating of claim 19, further comprising:
at least one component selected from the group consisting of thickeners, defoamers, surfactants, dispersants, matting agents, solvents, antimicrobial agents, pigments, hardeners, and combinations thereof.

22. A process for preparing the waterborne acrylic (co)polymer of claim 1, comprising:
providing a monomer mixture comprising a biobased ethyl acrylate; at least one other (meth)acrylate; and, optionally, at least one styrene;
combining a first portion of the monomer mixture with a solvent comprising water in a heated reactor;
adding at least one first initiator composition to the first portion of the monomer mixture and solvent in the heated reactor to cause initiation of polymerization and an exotherm;
mixing the resulting mixture at a temperature of maximum exotherm;
adding the remaining portion of the monomer mixture to the reactor; and
adding further at least one second initiator composition and agitating the resulting mixture until homogeneous,
thus providing the waterborne acrylic (co)polymer.

23. The process of claim 22, wherein the at least one first initiator composition and the at least one second initiator composition comprise the same initiator.

24. The process of claim 22, wherein at least one first initiator composition and the at least one second initiator composition comprise different initiators from one another.

25. The process of claim 22, wherein the process uses three initiator compositions, each different from the other.

26. The process of any claim 22, further comprising addition of at least one difunctional crosslinking compound.

27. The process of claim 26, wherein the difunctional crosslinking compound is diacetone acrylamide.

28. The process of claim 26, further comprising addition of a further crosslinking compound reactive with the difunctional crosslinking compound.

29. The process of claim 26, further comprising addition of adipic dihydrazide.
